(19) United States
(12) Patent Application Publication
(10) Pub. No.: US 2024/0430107 A1
(43) Pub. Date: Dec. 26, 2024

(54) PORTABLE UPDATE HUB

(71) Applicant: Election Systems & Software, LLC, Omaha, NE (US)

(72) Inventors: Alan Rosenbaum, Omaha, NE (US); Andrew Pruitt, Omaha, NE (US); Jeff Lewis, Omaha, NE (US); Bryan Cherry, Omaha, NE (US); Tyler Johnson, Omaha, NE (US); Kyle Dubbert, Omaha, NE (US)

(21) Appl. No.: 18/737,672

(22) Filed: Jun. 7, 2024

Related U.S. Application Data
(60) Provisional application No. 63/521,634, filed on Jun. 16, 2023.
(60) Provisional application No. 63/472,268, filed on Jun. 9, 2023.

(51) Int. Cl. H04L 9/32

(52) U.S. Cl. CPC H04L 9/3268

(57) ABSTRACT

A portable hub for updating a memory in a plurality of electronic devices is disclosed. The memory in the electronic devices is adapted to store an encryption algorithm and a data set. Each of said devices also has a security certificate, a remote wireless card and a processor. The portable hub includes a chassis and a grip on the chassis to facilitate movement of the portable hub by a single person from a first geographic location to a second geographic location. The portable hub also includes a power supply and a server having a main memory, an input and a display. The portable hub also includes a main wireless card coupled to the server and a security certificate associated with the server. The main memory is adapted to store a main encryption algorithm and a main data set to be transferred to the plurality of electronic devices. The server is programmed to provide a prompt via the display and to receive an answer to the prompt via the input. The server is adapted to be coupled to the plurality of electronic devices through a secure and encrypted wireless connection made between the main wireless card and the respective remote wireless cards to update the data set stored in the respective memories of the electronic devices. The power supply, the server, the main memory, and the main wireless card are secured to the chassis for support during movement of the portable hub. A local area network comprising a portable hub and a plurality of electronic devices is also disclosed. Method of using the portable hub and the local area network are also disclosed.

### CROSS REFERENCE TO RELATED APPLICATIONS

This application claims the benefit of U.S. Provisional Patent Application Nos. 63/521,634 filed Jun. 16, 2023 and 63/472,268 filed Jun. 9, 2023, which are incorporated by reference herein in their entirety.

### FIELD OF THE INVENTION

The present disclosure relates to a portable hub for updating a plurality of electronic devices through a wireless connection.

### BACKGROUND OF THE INVENTION

There are numerous electronic devices that include a memory and processor for performing a particular function. Over time, the data in the memory may become outdated or may need to be updated. Traditional methods for updating the memories in such devices used a hard-wire connection to the internet or a plug in USB device or other electronic device. Making a physical connection to the device to be updated is time consuming and requires unnecessary hardware. This is especially so when updating the contents of an electronic poll book for use in an election.

### SUMMARY OF THE INVENTION

As described more fully below, embodiments may include a portable hub for updating a memory in a plurality of electronic devices. The memory in the electronic devices is adapted to store an encryption algorithm and a data set. Each of said devices also has a security certificate, a remote wireless card and a processor. The portable hub includes a chassis and a grip on the chassis to facilitate movement of the portable hub by a single person from a first geographic location to a second geographic location. The portable hub also includes a power supply and a server having a main memory, an input and a display. The portable hub also includes a main wireless card coupled to the server and a security certificate associated with the server. The main memory is adapted to store a main encryption algorithm and a main data set to be transferred to the plurality of electronic devices. The server is programmed to provide a prompt via the display and to receive an answer to the prompt via the input. The server is adapted to be coupled to the plurality of electronic devices through a secure and encrypted wireless connection made between the main wireless card and the respective remote wireless cards to update the data set stored in the respective memories of the electronic devices. The power supply, the server, the main memory, and the main wireless card are secured to the chassis for support during movement of the portable hub. A local area network comprising a portable hub and a plurality of electronic devices is also disclosed. Method of using the portable hub and the local area network are also disclosed.

A further embodiment may provide a local area network including a plurality of electronic devices and a portable hub. The electronic devices include a memory and a security certificate wherein the memory is adapted to store an encryption algorithm and a data set. The electronic devices also include a remote wireless card and a processor. The portable hub includes a chassis and a grip on the chassis to facilitate movement of the portable hub by a single person from a first geographic location to a second geographic location. The portable hub also includes a power supply and a server having a main memory, an input and a display. The portable hub also includes a main wireless card coupled to the server. A security certificate is associated with the server. The main memory is adapted to store a main encryption algorithm, and a main data set to be transferred to the plurality of electronic devices. The server is programmed to provide a prompt via the display and to receive an answer to the prompt via the input. The server is adapted to be coupled to the plurality of electronic devices in a network formed through a secure and encrypted wireless connection made between the main wireless card and the respective remote wireless cards to update the data set stored in the respective memories of the electronic devices. The power supply, the server, the main memory, and the main wireless card are secured to the chassis for support during movement of the portable hub.

A still further embodiment provides a method of using the above portable hub embodiment including the steps of storing a main data set in the main memory and establishing a secure and encrypted communication channel between the main wireless card in the portable hub and the remote wireless cards in the plurality of electronic devices. The method further includes using the server to update the data set in the memory of the plurality of electronic devices with the main data set stored in the main memory via the secure and encrypted communication channel.

A yet further embodiment provides a method of using the above local area network embodiment including the steps of storing a main data set in the main memory and establishing a secure and encrypted communication channel between the main wireless card in the portable hub and the remote wireless cards in the plurality of electronic devices. The method further includes using the server to update the data set in the memory of the plurality of electronic devices with the main data set stored in the main memory via the secure and encrypted communication channel.

Other features will be in part apparent and in part pointed out hereinafter.

### BRIEF DESCRIPTION OF THE DRAWINGS

FIG. 1 shows a high level view of a portable hub on the right side updating a plurality of electronic devices.

FIG. 1A shows some of the components of the portable hub shown in FIG. 1.

FIG. 1B shows some of the components of the electronic devices shown in FIG. 1.

FIG. 2 shows a flow diagram at a high level for establishing secure communications between a portable hub and a plurality of electronic devices.

FIG. 3 shows a flow diagram for updating the memory in a plurality of electronic devices with the data stored in the portable hub.

FIGS. 4A to 4J show menu layouts for using a portable hub with a plurality of electronic devices.

Corresponding reference characters indicate corresponding parts throughout the drawings.

### DETAILED DESCRIPTION

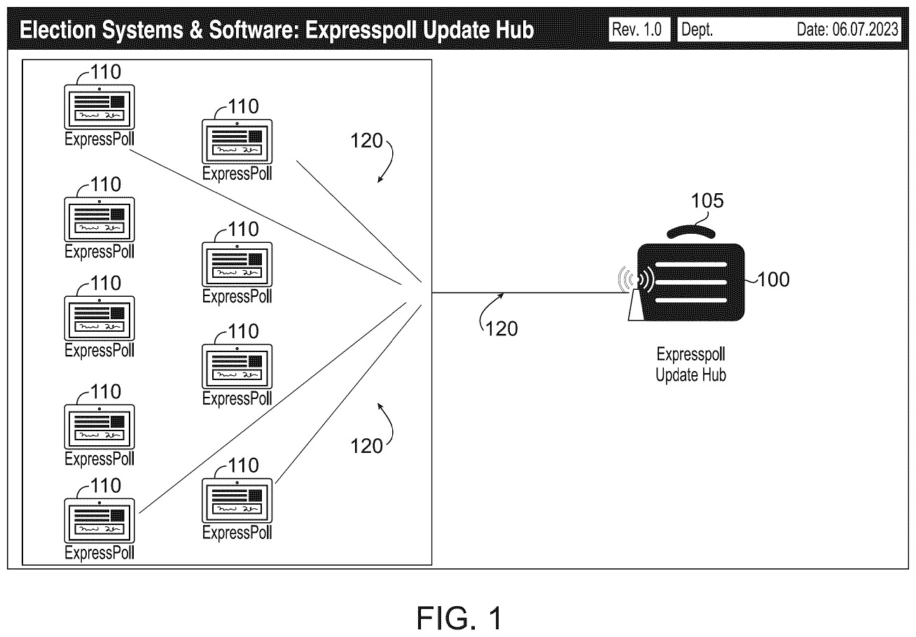

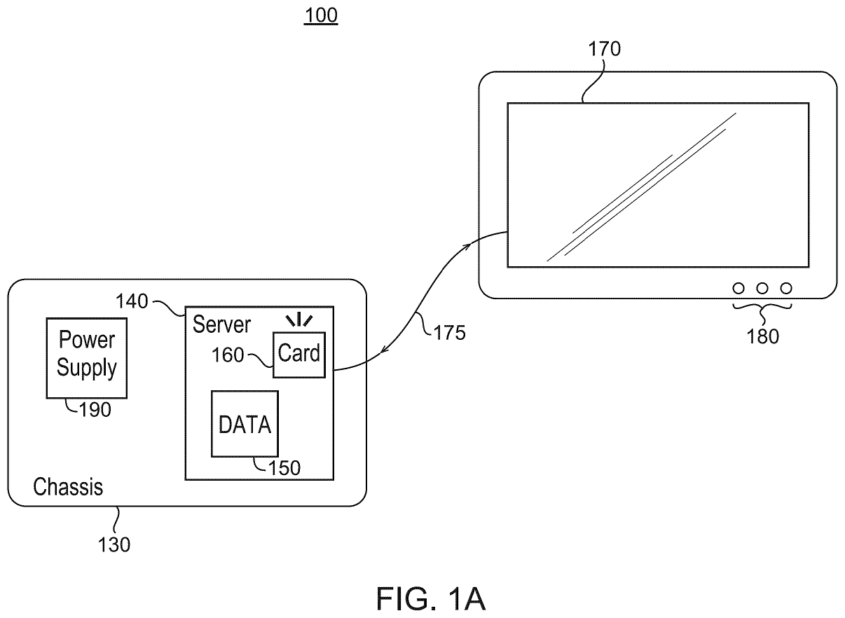

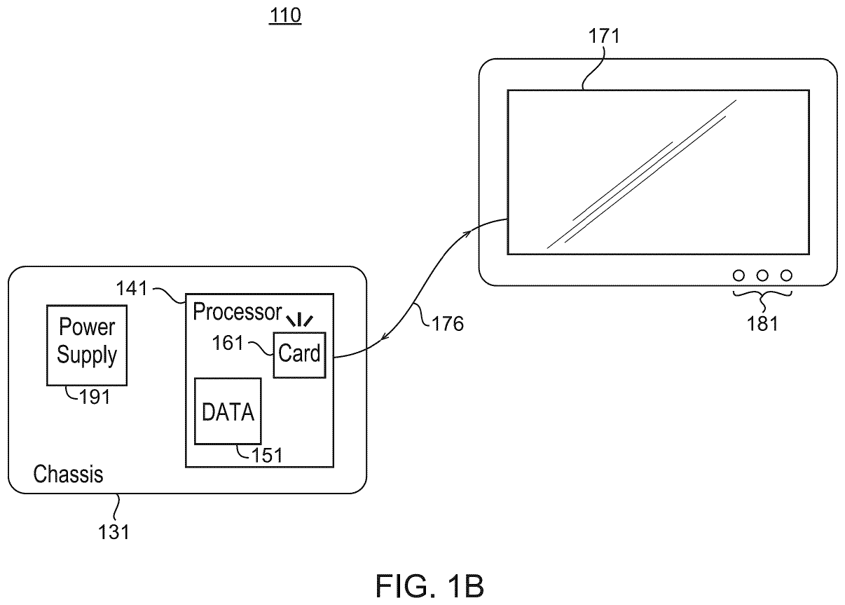

FIG. 1 shows a high level view of a portable hub 100 on the right side updating a plurality of electronic devices 110 through a wireless connection shown with various lines 120. The portable hub 100 includes the features described for the portable hub set forth below. The portable hub 100 preferably incorporates a small form factor personal computer running Windows Server, a Wireless Access point, firewall rules, custom certificates, and a tablet to display prompts and receive responses to thereby control the portable hub. The physical dimensions of the portable hub 100 preferably have the form factor of a small hard shell briefcase for portability with a screen or electronic tablet preferably affixed to an outer surface. A handle 105 provides a suitable grip for moving the portable hub from one geographic location to another. The portable hub 100 is thus preferably a self-contained mobile device management system. The electronic devices 110 of FIG. 1 include the features described for the electronic devices set forth below.

FIG. 1A shows some of the components of the portable hub 100. A chassis 130 may be formed as a part of the form factor for portable hub 100, or it may be a separate structure physically attached to the portable hub 100. In either event, chassis 130 supports a server 140 that comprises a processor and related components (not shown) for controlling the operation of the portable hub 100. The server 140 is coupled to a memory 150 for storing and retrieving software, object code, data, encryption codes, algorithms, security certificates and the like. Memory 150 may include solid state memory, a cache, registers, or other common memory elements in or adjacent to the processor. The server 140 is also coupled to a wireless communication card 160 for selectively communicating with the electronic devices 110.

The server 140 is coupled to a display 170 via a line 175. Line 175 may be a wire, integrated circuit connector, or other electrical conductor. Display 170 is preferably a touchscreen display for displaying information and graphics to the user, and for receiving input back from the user via the touch screen. Display 170 is preferably an electronic tablet or similar device secured to an outside surface of the form factor of portable hub 100 or secured to internal mechanics of the portable hub 100 that allow the electronic tablet or similar device to move into position for viewing and receiving input when the form factor of the portable hub is opened. Alternatively or additionally, the display 170 may include fixed place manual switches 180 for receiving input from the user. The manual switches 180 may be incorporated into the form factor of the display 170, as shown. The manual switches 180 may also be provided through a discrete input device such as a mouse, key pad, or other common input.

A power supply 190 provides electrical power to all of the components of portable hub 100 that require electrical power. Power supply 190 may include an electrical cord and plug for connection to conventional AC power, as well as standard circuitry such as a rectifier bridge and capacitor, or an inverter, or the like (none shown), for providing an appropriate type of power to the components of portable hub 100. Alternatively, power supply 190 may include a battery and control circuitry (neither shown) for providing appropriate DC power to the components of portable hub 100.

FIG. 1B shows some of the components of the electronic devices 110. A chassis 131 may be formed as a part of the form factor for electronic devices 110, or it may be a separate structure physically attached to electronic devices 110. In either event, chassis 131 supports a processor circuit board 141 that comprises a processor and related components (not shown) for controlling the operation of the electronic devices 110. The processor 141 is coupled to a memory 151 for storing and retrieving software, object code, data, encryption codes, algorithms, security certificates and the like. Memory 151 may include solid state memory, a cache, registers, or other common memory elements in or adjacent to the processor 141. The processor 141 is also coupled to a wireless communication card 161 for selectively communicating with the portable hub 100 and/or the other electronic devices 110.

The processor 141 is coupled to a display 171 via a line 176. Line 176 may be a wire, integrated circuit connector, or other electrical conductor. Display 171 is preferably a touchscreen display for displaying information and graphics to the user, and for receiving input back from the user via the touch screen. Display 171 is preferably incorporated into the form factor of the electronic devices 110. Display 171 may also be an electronic tablet or similar device secured to an outside surface of the form factor of electronic devices 110 or secured to internal mechanics of the electronic devices 110 that allow the electronic tablet or similar device to move into position for viewing and receiving input when the form factor of the respective electronic device is opened. Alternatively or additionally, the display 171 may include fixed place manual switches 181 for receiving input from the user. The manual switches 181 may be incorporated into the form factor of the display 171, as shown. The manual switches 181 may also be provided through a discrete input device such as a mouse, key pad, or other common input.

A power supply 191 provides electrical power to all of the components of each electronic device 110 that require electrical power. Power supply 190 may include an electrical cord and plug for connection to conventional AC power, as well as standard circuitry such as a rectifier bridge and capacitor, or an inverter, or the like (none shown), for providing an appropriate type of power to the components of the electronic devices 110. Alternatively, power supply 190 may include a battery and control circuitry (neither shown) for providing appropriate DC power to the components of the electronic devices 110.

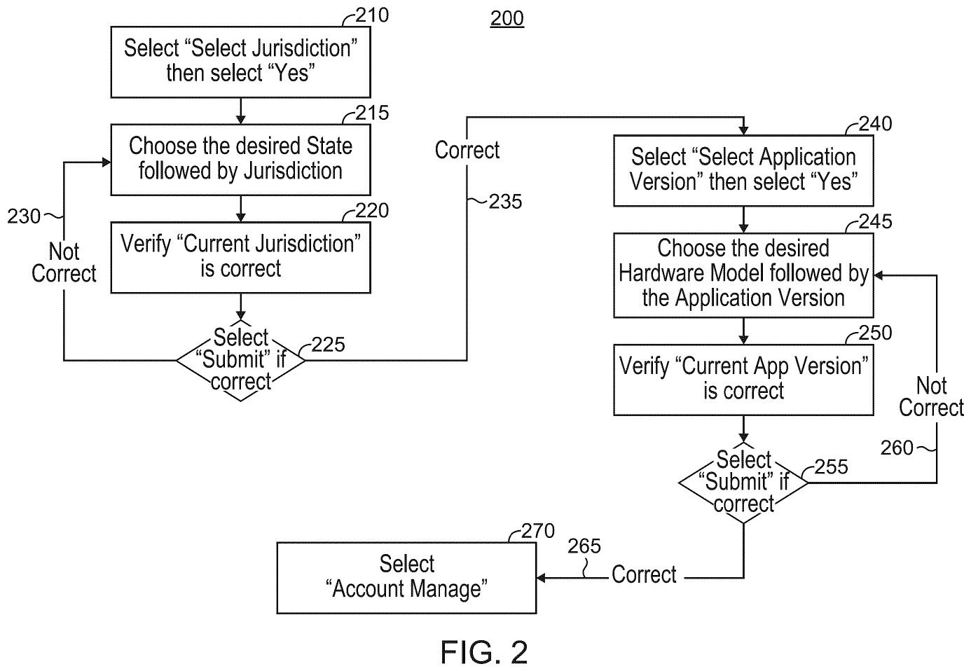

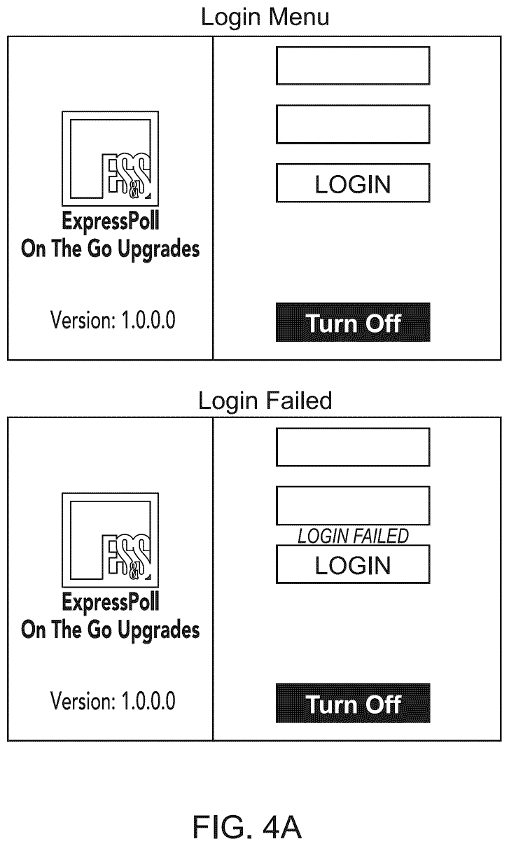

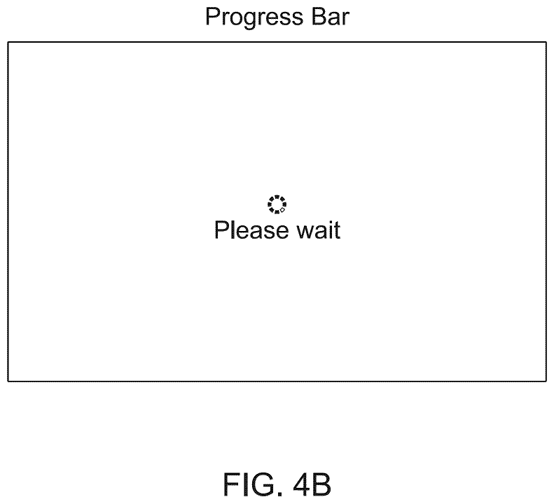

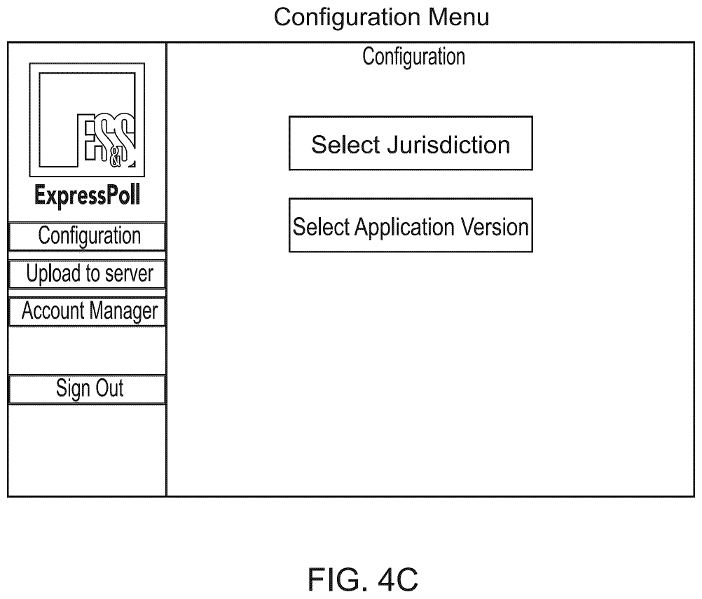

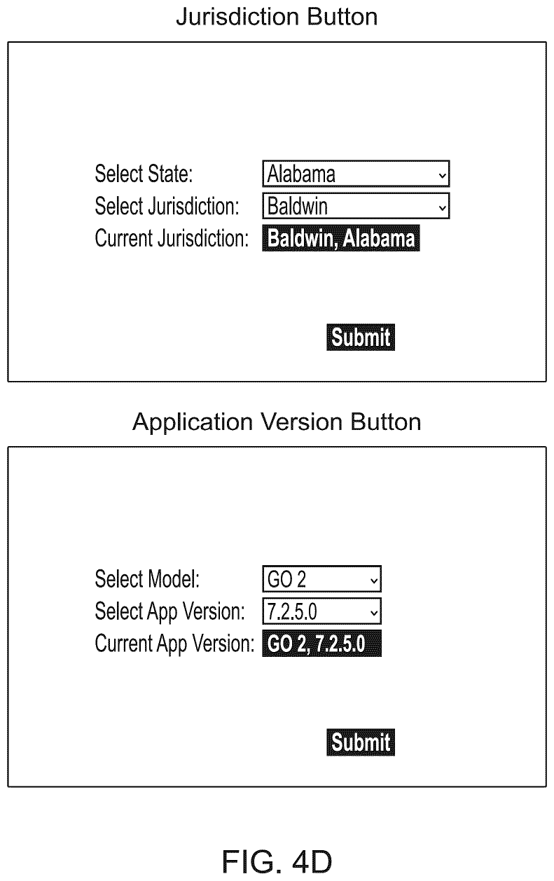

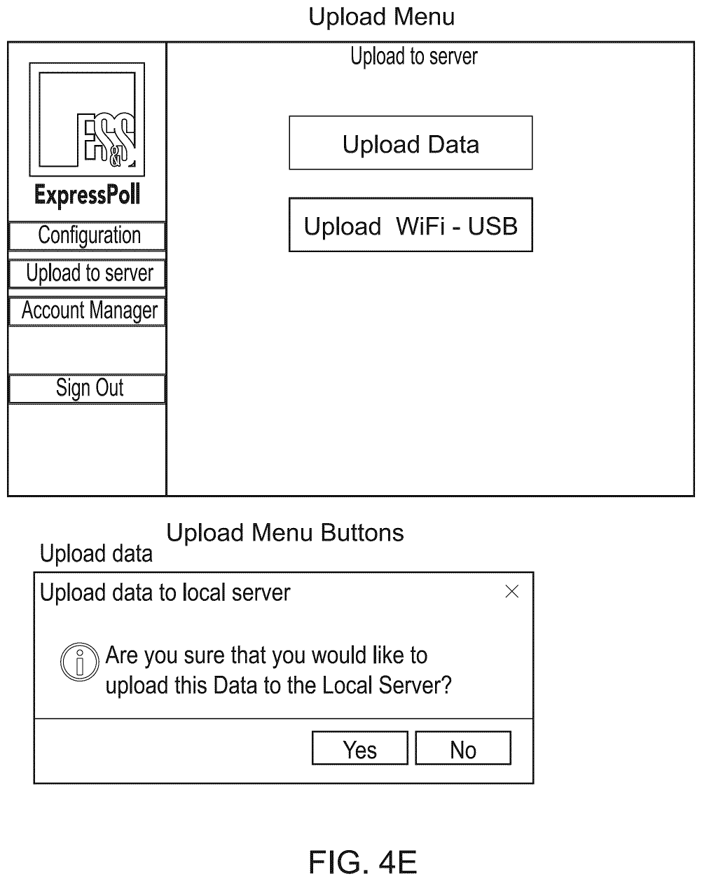

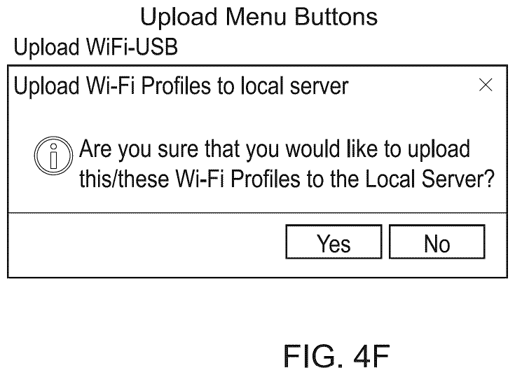

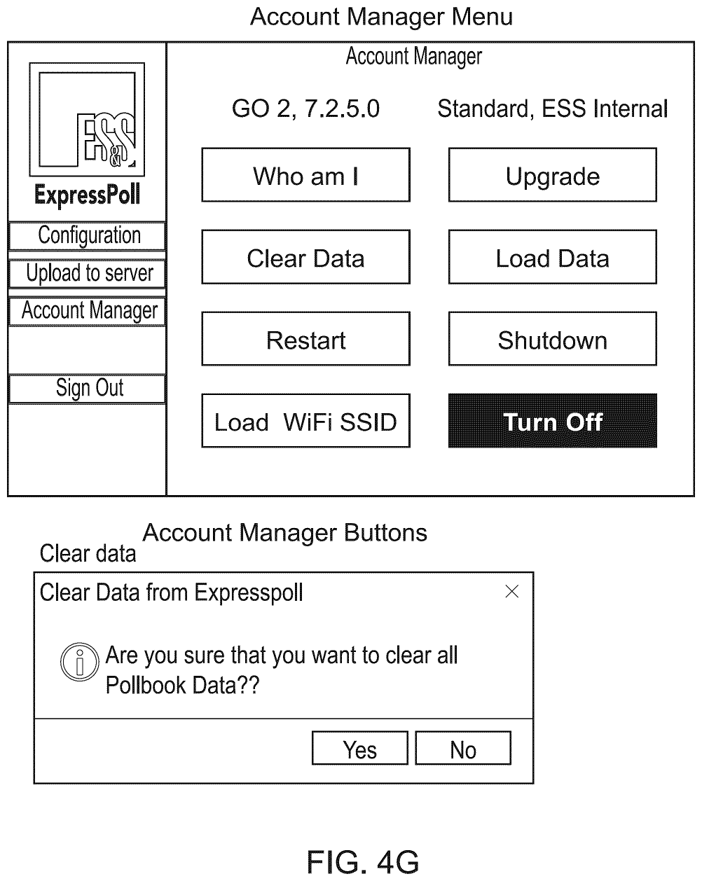

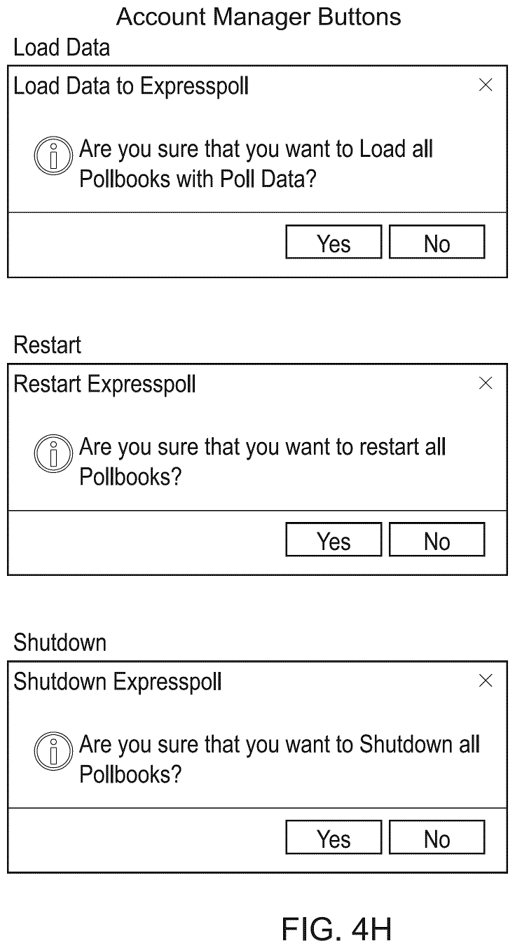

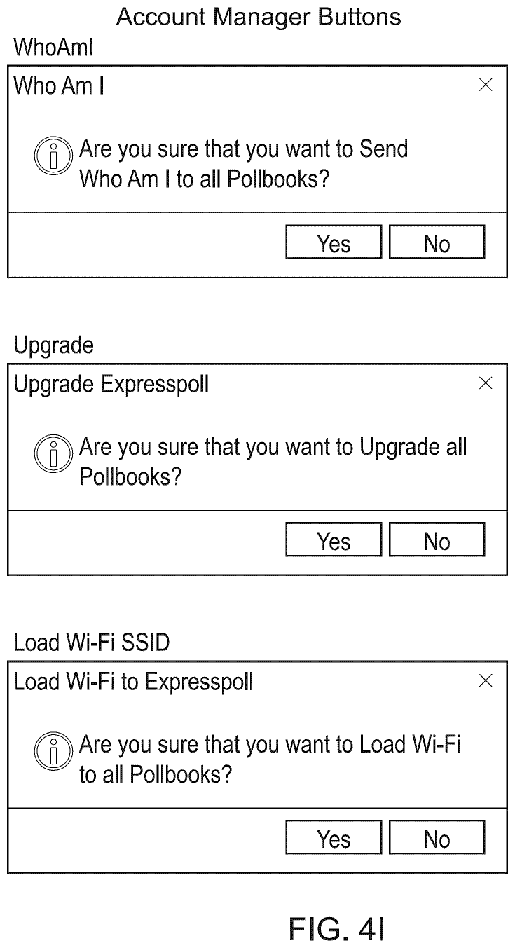

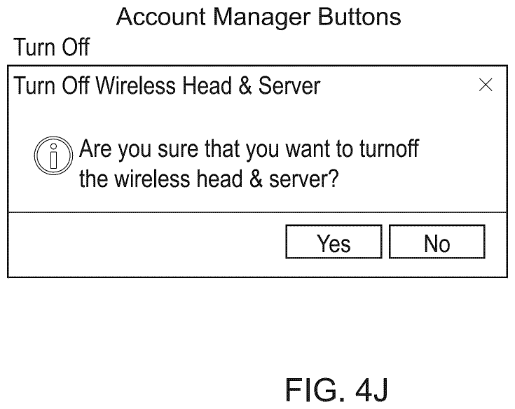

FIG. 2 shows a flow diagram 200 for establishing secure communications between the portable hub 100 and the plurality of electronic devices 110 in FIG. 1. In block 210, the user is offered the “Select Jurisdiction” option and then can choose that option with a “Yes.” In block 215, the user chooses a desired state and jurisdiction. FIGS. 4C & 4D show the graphics for this state and jurisdiction functionality. The memory 150 in the portable hub 100 preferably includes data for all of the available states and jurisdictions so that a single portable hub 100 may be used to service and update electronic devices 110 found in many different geographic locations. In block 220, the user is asked to confirm that the currently selected jurisdiction is the correct jurisdiction of interest. If the selected jurisdiction is not correct, then the user so indicates and the program returns to block 215 via pathway 230 for completion, as above. If the selected jurisdiction is correct, then the user so indicates and the program proceeds to block 240 via pathway 235.

In block 240, the user is offered the “Select Application Version” option and can choose that option with a “Yes.” The display 170 then displays identifiers for each of the available hardware models of the electronic devices 110 and identifiers for each of the available software application versions. This information is preferably displayed to the user through a drop down box on the display 170. FIG. 4D shows the graphics for this application version selection functionality. Other forms of display and/or graphics may also be used. In block 245, the user selects the particular hardware model of the electronic devices 110 and the software application version to be loaded onto the respective electronic devices 110 for updating.

In block 250, the user is asked to verify that the currently selected hardware model and software application version are correct. In block 255, if either selection is not correct, then the user so indicates and the program returns to block 245 via pathway 260 for completion, as above. If both selections are correct, then the user so indicates in block 255 and the program proceeds to block 270 via pathway 265. Block 270 returns the user to the Account Manager Menu options shown in FIG. 4G.

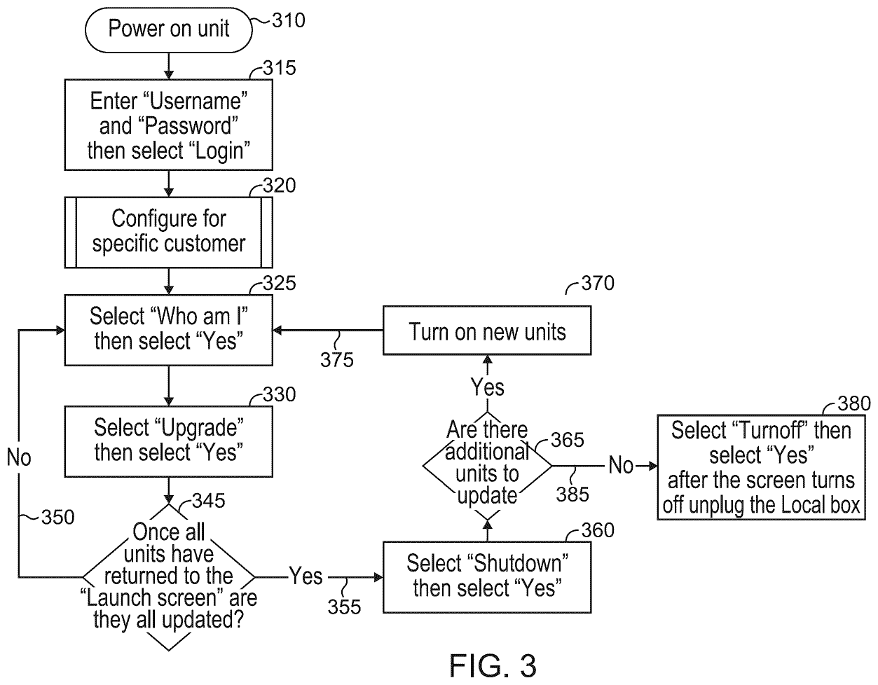

FIG. 3 shows a flow diagram 300 for updating the memory 151 in a plurality of electronic devices 110. The memory 151 is updated with the data stored in the memory 150 of the portable hub 100. For example, a warehouse may store a large number of electronic poll books that are used during an election. In order to update the electronic poll books with the voter information for the next election, the portable hub 100 efficiently performs the update where the poll books are represented by the electronic devices 110 in FIG. 1.

More particularly, in block 310, the user turns on the portable hub 100 with either the battery or wall current for power supply 190. In block 315, the user enters their “username” and password to login into server 140. Other login credentials could also be used, including dual factor or multi-factor security protocols. FIGS. 4A & 4B show graphics that are displayed for the login process. After logging in, the server 140 in block 320 displays a drop down box with the names of all of the available states and jurisdictions via display 170. The user then selects the appropriate state and jurisdiction for the electronic devices 110 to be updated. On the first time the flow diagram 300 is used to set up a customer, block 320 also uses a naming function stored in memory 150 in order to provide a name for that specific jurisdiction. During future uses of flow diagram 300, the name of the jurisdiction can be used during updating of the electronic devices 110.

For users who are authorized to update different electronic devices 110 for different customers or owners of those devices, the login process at block 315 will let the user enter a layer where they have full access to all of the relevant devices 110 and updates for those devices. For users who are only authorized to update specific devices 110 or provide only specific updates, those users are preferably logged into a different layer at block 315 that is limited to just those authorized functions.

After the jurisdiction is appropriately named in block 320, the user moves to block 325 where the menu options from FIGS. 4G to 4J that are appropriate for their level of access are displayed in display 170. In order to update the data stored in the memories 151 of electronic devices 110, the user first turns on each of the devices 110 to be updated. The user next selects the “Who Am I” menu option in FIG. 4G. In response to the selection of the “Who Am I” menu option in block 425, server 410 sends a command through its wireless communication card 160 that is received by each of the electronic devices 110 through their respective wireless communication cards 161. The electronic devices 110 each respond back with an identifier and status update. The identifier is preferably the serial number of the electronic device 110, the hardware variant of the device 110, and the version number of the software currently loaded onto the device 110. The server 140 performs this “Who Am I” function until all of the electronic devices 110 have responded with their respective identifiers and status update, and the server 140 has stored this data in memory 150. If there are too many electronic devices to be updated in a single batch, or if there is a predetermined limit on the number of electronic devices to be updated in a single batch, then the user only turns on a subset of the devices 110 to form the first batch and thus the server 140 stops receiving identifiers and status updates after the initial batch has sent their identifiers and status updates.

The updating process proceeds to block 330 where the user selects the Upgrade menu option. The process then performs the flow diagram 200 in FIG. 2 in order to select the jurisdiction and hardware variant of the devices 110 to be updated, and the particular software application version to be uploaded into the memories 151 of the electronic devices 110 during the updating process. The server 140 uploads the selected software application version into each of the devices 110 through the wireless communication cards 160 and 161. The server 140 and electronic devices 110 are preferably organized into a local area network to facilitate the updating process and for any other communication needs that may arise or that are required to perform any of the menu options in FIGS. 4G to 4J. In block 345, the server 140 determines whether all of the electronic devices 110 in the first batch have been updated with the respective selected software version. If all of the electronic devices 110 have not been updated yet, then then the process loops back via path 350 to block 325 and repeats this loop until all of the devices 110 in the first batch have been updated with the new software variant.

After all of the devices 110 in the first batch have been updated with the selected software application version, the process proceeds via path 355 to block 360. In block 360, the server sends a command to each of the devices 110 in the first batch via the wireless communication card 160. Those devices 110 receive the command via their own respective wireless communication cards 161 and respond by shutting down. Those devices 110 have now been updated with the preferred software application version.

In block 365, the server 140 determines whether there are any additional electronic devices 110 that remain to be updated, e.g., whether there are any other batches of devices that need to be updated. If so, then in block 370 the user turns on all of the electronic devices 110 in the next batch of devices 110 to be updated. The process then loops back to block 325 via path 375 to update the next batch of devices 110. This looping continues until all of the batches of devices 110 have been updated and then shutdown in block 360.

After such updating is completed, the user responds to the server 140 in block 365 that there are no additional devices 110 to be updated. The process continues to block 380 via path 385 where the server 140 displays the menu option from FIG. 4G to allow the user to turn off the portable hub 100. The other menu options in FIGS. 4G to 4J are also displayed to allow the use to select other options.

The menu option to “Load Data” in FIG. 4G allows the user to upload data into the memory 150 of portable hub 100. Such uploaded data can be object code, operating software, security certificates, encryption codes and algorithms, new data to be loaded into the memories of electronic devices 110, or any other data that may need to be loaded into memory 150 for any purpose. FIGS. 4E and 4F show graphics for implementing this data upload menu option. As seen, the data can be uploaded from a USB drive physically inserted into the portable hub 100. The data can also be uploaded via a WiFi network through the wireless communication card 160. Large data files such as new election data are preferably unzipped before being loaded into the memory 150. Such data is preferably stored in a folder named “StorageData” on the root of the USB drive so that its identify and purpose are easily recognized and so that such data is accurately uploaded into the memories 151 of electronic devices 110.

The menu option to “Clear Data” in FIG. 4G allows the user to clear all data and anything else that resides in the memory 151 of any electronic devices 110 that are turned on and connected via wireless communication cards 160 and 161 to the portable hub 100. Upon selecting this menu option, the memories 151 in all such devices 110 are cleared.

The menu option to “Restart” in FIGS. 4G and 4H allows the user to restart all of the electronic devices 110 that are turned on and connected via wireless communication cards 160 and 161 to the portable hub 100. Upon selecting this menu option, all such connected electronic devices 110 are restarted.

The menu option to “Shutdown” in FIGS. 4G and 4H allows the user to shut down all of the electronic devices 110 that are turned on and connected via wireless communication cards 160 and 161 to the portable hub 100. Upon selecting this menu option, all such connected electronic devices 110 are shut down.

The menu option to “Turn Off” in FIGS. 4G and 4J allows the user to turn off the portable hub 100 and stop any further functions otherwise controlled by the portable hub 100 from occurring. Upon selecting this menu option, the portable hub 100 turns offs.

As noted above, inputs 180 and 181 may take the form of actual button switches or may take the form of the touch screen of displays 170 and 171, or may take any other conventional form for allowing a user to provide input. The graphics shown in the menu options of FIGS. 4G to 4J are one preferable way to use the displays 170 and/or 171 to present issues and receive input from the user. The security certificates, encryption algorithms, encryption codes and like security measures may be stored or embedded in the memories 150 and 151, may be embedded or hard coded into the circuitry and/or related components used with server 140 and/or processor 141, or may be provided through any other suitable means.

As a person of ordinary skill in the art would recognize, methods of using the portable hub 100 with the electronic devices 110 as more fully explained above through the communication link shown in FIG. 1, the flow diagrams in FIGS. 2 and 3, and the menu layouts and options in FIGS. 4A to 4J are disclosed and form a part of the inventions disclosed herein.

Thus, the invention is seen to include the method of using the portable hub 100 in all variations described above to store a main data set in the memory 150, to establish a secure and encrypted communication channel between the main wireless card 160 in the portable hub 100 and the remote wireless cards 161 in the plurality of electronic devices 110, to use the server 140 to update the data set in the memory 151 of the plurality of electronic devices 110 with the main data set stored in the main memory 150 via the secure and encrypted communication channel. This updating can occur without any direct connection or access to the internet during such updating.

In use, the portable hub 100 and/or local area network formed with the portable hub 100 and electronic devices 110 can be used with a number of electronic devices 110 ranging from 2 to 100 devices, 50 to 250 devices, 150 to 500 devices, or even 500 to 5,000 devices.

Having described the invention in detail, it will be apparent that modifications and variations are possible without departing from the scope of the invention defined in the appended claims.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

1. A portable hub for updating a memory in a plurality of electronic devices, the memory adapted to store an encryption algorithm and a data set, each of said devices comprising a security certificate, a remote wireless card and a processor, the portable hub comprising:
a chassis;
a grip on the chassis to facilitate movement of the portable hub by a single person from a first geographic location to a second geographic location;
a power supply;
a server having a main memory, an input and a display;
a main wireless card coupled to the server;
wherein a security certificate is associated with the server;
wherein the main memory is adapted to store a main encryption algorithm and a main data set to be transferred to the plurality of electronic devices;
wherein the server is programmed to provide a prompt via the display and to receive an answer to the prompt via the input;
wherein the server is adapted to be coupled to the plurality of electronic devices through a secure and encrypted wireless connection made between the main wireless card and the respective remote wireless cards to update the data set stored in the respective memories of the electronic devices; and
wherein the power supply, the server, the main memory, and the main wireless card are secured to the chassis for support during movement of the portable hub.

2. The portable hub of claim 1 where the plurality of electronic devices comprises a plurality of electronic poll books adapted for use during an election and wherein the data set stored in the memory of the electronic poll books provides a plurality of voter information.

3. The portable hub of claim 1 wherein the security certificate stored in the memory of the portable hub is the same as the security certificate stored in the main memory of the server.

4.-6. (canceled)

7. The portable hub of claim 1 wherein the server in the portable hub is adapted to form a local area network with the plurality of electronic devices, and where the server updates the memory in the respective portable electronic devices through communications made through the local area network.

8. The portable hub of claim 1 wherein the server in the portable hub is adapted to update the memory in the respective portable electronic devices without the use of any connection to an internet while the respective portable electronic devices are being updated.

9.-12. (canceled)

13. A local area network comprising:
a plurality of electronic devices wherein each electronic device comprises:
a memory;
a security certificate;
wherein the memory is adapted to store an encryption algorithm and a data set;
a remote wireless card; and
a processor,
a portable hub comprising:
a chassis;
a grip on the chassis to facilitate movement of the portable hub by a single person from a first geographic location to a second geographic location;
a power supply;
a server having a main memory, an input and a display;
a main wireless card coupled to the server;
wherein a security certificate is associated with the server;
wherein the main memory is adapted to store a main encryption algorithm, and a main data set to be transferred to the plurality of electronic devices;
wherein the server is programmed to provide a prompt via the display and to receive an answer to the prompt via the input;
wherein the server is adapted to be coupled to the plurality of electronic devices in a network formed through a secure and encrypted wireless connection made between the main wireless card and the respective remote wireless cards to update the data set stored in the respective memories of the electronic devices; and
wherein the power supply, the server, the main memory, and the main wireless card are secured to the chassis for support during movement of the portable hub.

14. The local area network of claim 13 wherein:
the plurality of electronic devices comprises a plurality of electronic poll books adapted for used during an election and wherein the data set stored in the memory of the electronic poll books provides a plurality of voter information; or
the security certificate stored in the memory of the portable hub is the same as the security certificate stored in the main memory of the server.

15. (canceled)

16. The local area network of claim 13 wherein the encryption algorithm stored in the memory of the portable hub corresponds to the encryption algorithm stored in the main memory of the server to facilitate an encrypted communication between the portable hub and the plurality of electronic devices.

17. The local area network of claim 13 wherein;
the security certificate is embedded in each of the portable electronic devices; or
the security certificate is embedded in the portable hub.

18. (canceled)

19. The local area network of claim 13 wherein the server in the portable hub is adapted to form a local area network with the plurality of electronic devices, and where the server updates the memory in the respective portable electronic devices through communications made through the local area network.

20. The local area network of claim 13 wherein the server in the portable hub is adapted to update the memory in the respective portable electronic devices without the use of any connection to an internet while the respective portable electronic devices are being updated.

21.-24. (canceled)

25. A method of using the portable hub of claim 1 comprising the steps of:
storing a main data set in the main memory;
establishing a secure and encrypted communication channel between the main wireless card in the portable hub and the remote wireless cards in the plurality of electronic devices;
using the server to update the data set in the memory of the plurality of electronic devices with the main data set stored in the main memory via the secure and encrypted communication channel.

26. A method of using the local area network of claim 13 comprising the steps of:
storing a main data set in the main memory;
establishing a secure and encrypted communication channel between the main wireless card in the portable hub and the remote wireless cards in the plurality of electronic devices;
using the server to update the data set in the memory of the plurality of electronic devices with the main data set stored in the main memory via the secure and encrypted communication channel.

27. The portable hub of claim 1 further comprising a number of electronic devices ranging from 2 to 100.

28. The portable hub of claim 1 further comprising a number of electronic devices ranging from 50 to 250.

29.-30. (canceled)

31. The method of claim 25 for use with a number of electronic devices ranging from 2 to 100.

32. The method of claim 25 for use with a number of electronic devices ranging from 50 to 250.

33.-35. (canceled)

36. The method of claim 25 wherein the step of using the server to update the data set in the memory of the plurality of electronic devices with the main data set stored in the main memory via the secure and encrypted communication channel is performed without any connection or access to the internet during said updating.

37. The portable hub of claim 1 wherein the portable hub further comprises a suitcase and wherein the suitcase supports or contains all of the other components of the portable hub.

38. The method of claim 25 further comprising the step of using the portable hub wherein the portable hub further comprises a suitcase and wherein the suitcase supports or contains all of the other components of the portable hub.
